(19) United States
(12) Patent Application Publication
(10) Pub. No.: US 2014/0289652 A1
(43) Pub. Date: Sep. 25, 2014

(54) ELECTRONIC DEVICE AND METHOD FOR ACTIVATING APPLICATION AFTER UNLOCKING

(71) Applicants: HON HAI PRECISION INDUSTRY CO., LTD., New Taipei (TW); Fu Tai Hua Industry (Shenzhen) Co., Ltd., Shenzhen (CN)

(72) Inventor: ZE-PENG CAI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/190,143

(22) Filed: Feb. 26, 2014

(30) Foreign Application Priority Data
Mar. 21, 2013 (CN) 2013100911310

(51) Int. Cl. G06F 3/0484

(52) U.S. Cl. CPC G06F 3/04842; G06F 3/04847
USPC 715/762; 715/811

(57) ABSTRACT

A method for activating applications of an electronic device by setting one or more time intervals and one or more applications of the electronic device to correspond to the one or more time intervals. When the electronic device is unlocked and the current time is located within one of the one or more time intervals, an application corresponding to the one of the time intervals where the current time is located can be automatically activated.

### BACKGROUND

1. Technical Field

Embodiments of the present disclosure relate to application management of electronic devices, and particularly, to a method for activating applications of an electronic device after the electronic device has been unlocked.

2. Description of Related Art

Many electronic devices, such as smart phones and tablet computers, may be installed with a plurality of applications (APP). To avoid inadvertent or unintended operations of the APP, the electronic devices employ unlocking methods or functions. Various kinds of unlocking methods applied in the electronic devices include unlocking by gestures, passwords, and patterns. When a user wants to open a commonly used application in the electronic device, the user must first unlock the electronic device before operating an icon to activate the application, which is inconvenient and time consuming. Therefore, there is room for improvement in the art.

### BRIEF DESCRIPTION OF THE DRAWINGS

FIG. 1 is a schematic block diagram illustrating one embodiment of an electronic device.

FIG. 2 is a flowchart of one embodiment of a method for activating applications of the electronic device using the functional modules of the electronic device of FIG. 1.

FIG. 3 shows a schematic diagram of a notification interface of the electronic device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

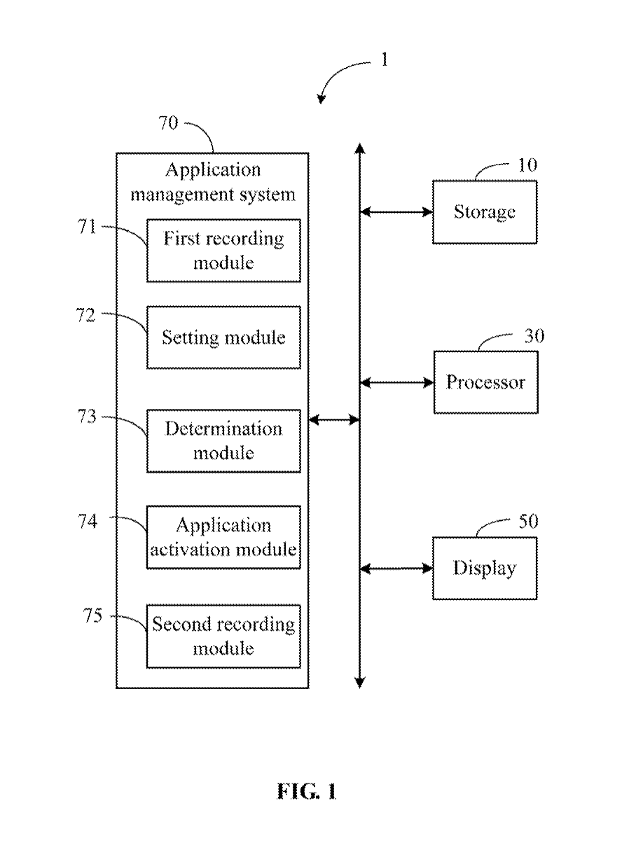

FIG. 1 is a schematic block diagram illustrating one embodiment of an electronic device 1. The electronic device 1 includes a storage 10, a processor 30, a display 50, and an application management system 70. In the embodiment, the electronic device 1 can be a smart phone, a mobile Internet device (MID), or a tablet computer. FIG. 1 shows one embodiment of the electronic device 1, and it can include more or fewer components than those shown in the embodiment, or have a different configuration of the components.

The application management system 70 can include a plurality of programs in the form of one or more computerized instructions stored in the storage 10 and executed by the processor 30 to perform operations of the electronic device 1. In the embodiment, the application management system 70 includes a first recording module 71, a setting module 72, a determination module 73, an application activation module 74, and a second recording module 75. The storage 10 can be an external or embedded storage medium of the electronic device 1, such as a secure digital memory (SD) card, a Trans Flash (TF) card, a compact flash (CF) card, or a smart media (SM) card.

In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

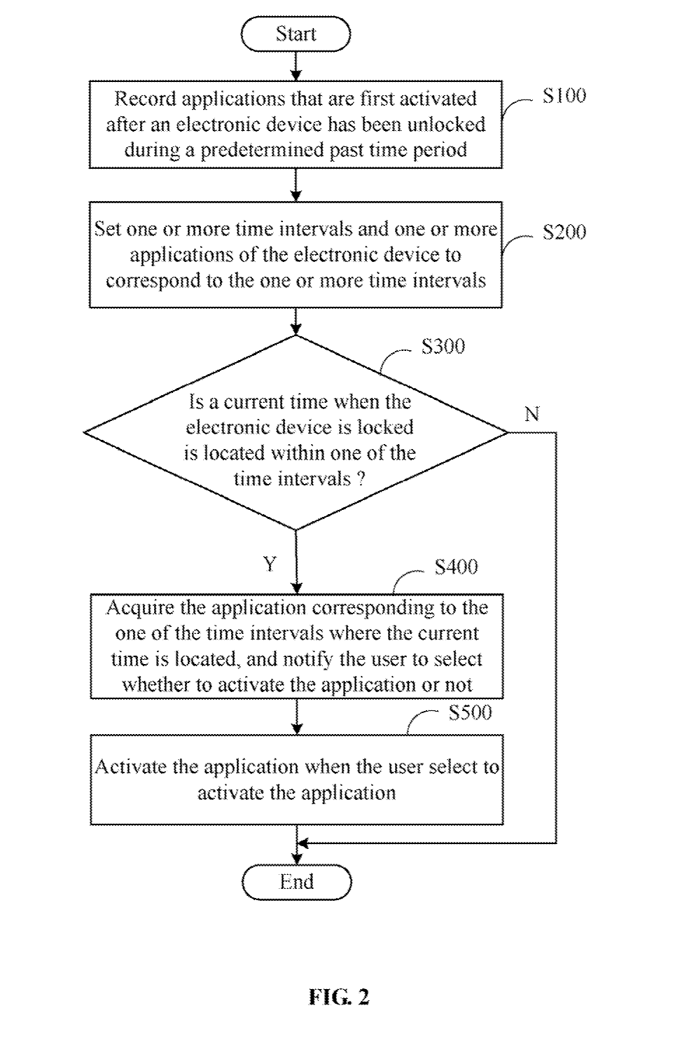

FIG. 2 shows a flowchart of one embodiment of a method for activating applications of the electronic device after the electronic device is unlocked using the functional modules of the application management system 70 of FIG. 1. Depending on the embodiment, additional steps may be added, others removed, and the ordering of the steps may be changed.

In step S100, the first recording module 71 records applications that are first activated after the electronic device 1 has been unlocked during a predetermined past time period, such as the past 15 or 30 days. In the embodiment, the first recording module 71 stores basic information of the applications, such as application name, directory where the application is stored, and time information when the application is activated, in the storage 10.

In step S200, the setting module 72 sets one or more time intervals (e.g., 22:00-23:00 and 12:30-13:30), and sets one or more applications of the electronic device 1 to correspond to the one or more time intervals, each set application corresponding to one of the one or more time intervals. In this embodiment, a recorded application which is first activated the most times during the predetermined past time period is set to correspond to a corresponding time interval.

In one embodiment, when an application is activated in a same time interval everyday of the predetermined past time period, the second recording module 75 records the application and sets the application to correspond to the corresponding time interval. In other embodiments, the application corresponding to each of the time intervals can be manually set by the user. The electronic device 1 can provide a user interface for a user to manually set the application corresponding to each of the time intervals. When the user interface is displayed on the display 50, all of the applications installed on the electronic device 1 are displayed via the user interface. The one or more applications that are set to correspond to the one or more time intervals are selected from the applications displayed on the user interface.

In step S300, when the electronic device 1 is unlocked, the determination module 73 determines whether a current time is located within one of the time intervals. If the current time is located within one of the one or more time intervals, step S400 is implemented. Otherwise, the procedure ends.

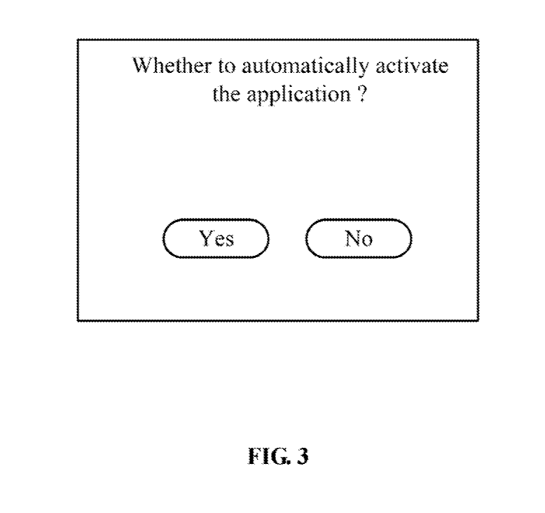

In step S400, the application activation module 74 acquires the application corresponding to the one of the time intervals where the current time is located, and notifies the user to select whether to activate the application or not. For example, as shown in FIG. 3, the application activation module 74 can display a dialog box on the display 50 to notify the user. The dialog box includes text information to notify the user and operating options.

In step S500, the application activation module 74 activates the application when the user selects to activate the application.

In other embodiments, the application corresponding to the one of the time intervals where the current time is located can be directly activated without notifying the user. If the current time when the electronic device 1 is locked is not located within one of the time intervals, the determination module 73 triggers the electronic device 1 to output a predetermined notification message to notify the user. The predetermined notification message can be a text message displayed via the display 50 or a voice message.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for activating applications of an electronic device, the method comprising:
setting one or more time intervals and one or more applications of the electronic device to correspond to the one or more time intervals, each application corresponding to one of the one or more time intervals;
in response to the electronic device being unlocked, determining whether a current time when the electronic device is locked is located within one of the one or more time intervals;
acquiring an application corresponding to the one of the time intervals where the current time is located, when the current time is located within the one of the one or more time intervals; and
notifying a user to select whether to activate the application or not, and activating the application when the user selects to activate the application.

2. The method according to claim 1, wherein the one or more applications corresponding to the one or more time intervals are manually set by the user.

3. The method according to claim 2, wherein the electronic device comprises a user interface configured to manually set the one or more applications.

4. The method according to claim 3, wherein when the user interface is displayed on a display of the electronic device, all of the applications installed on the electronic device are displayed via the user interface, and the one or more applications corresponding to the one or more time intervals are selected from the applications displayed via the user interface.

5. The method according to claim 1, further comprising:
recording applications that are first activated after the electronic device has been unlocked during a predetermined past time period; and
setting a recorded application which is first activated the most times to correspond to a corresponding time interval.

6. The method according to claim 5, wherein basic information of each recorded application is stored in a storage of the electronic device, the basic information of each recorded application comprises an application name, a directory where the application is stored, and time information when the application is activated.

7. The method according to claim 1, further comprising:
recording an application that is activated in a same time interval at everyday of a predetermined past time period; and
setting the recording application to correspond to a corresponding time interval.

8. An electronic device, comprising:
a display;
a storage;
a processor; and
one or more programs executed by the processor to perform a method for activating applications of the electronic device, the method comprising:
setting one or more time intervals and one or more applications of the electronic device to correspond to the one or more time intervals, each application corresponding to one of the one or more time intervals;
in response to the electronic device being unlocked, determining whether a current time when the electronic device is locked is located within one of the one or more time intervals;
acquiring an application corresponding to the one of the time intervals where the current time is located, when the current time is located within the one of the one or more time intervals; and
notifying a user to select whether to activate the application or not, and activating the application when the user selects to activate the application.

9. The electronic device according to claim 8, wherein the one or more applications corresponding to the one or more time intervals are manually set by the user.

10. The electronic device according to claim 9, wherein the electronic device comprises a user interface configured to manually set the one or more applications.

11. The electronic device according to claim 10, wherein when the user interface is displayed on the display of the electronic device, all of the applications installed on the electronic device are displayed via the user interface, and the one or more applications corresponding to the one or more time intervals are manually selected from the applications displayed via the user interface.

12. The electronic device according to claim 8, wherein the method further comprises:
recording applications that are first activated after the electronic device has been unlocked during a predetermined past time period; and
setting a recorded application which is first activated the most times during the predetermined past time to correspond to a corresponding time interval.

13. The electronic device according to claim 12, wherein basic information of each recorded application is stored in the storage of the electronic device, the basic information of each recorded application comprises an application name, a directory where the application is stored, and time information when the application is activated.

14. The electronic device according to claim 8, wherein the method further comprises:
recording an application that is activated in a same time interval at everyday of a predetermined past time period; and
setting the recording application to correspond to a corresponding time interval.
